(19) United States
(12) Patent Application Publication
(10) Pub. No.: US 2024/0172293 A1
(43) Pub. Date: May 23, 2024

(54) SYSTEMS AND METHODS FOR REFERENCE SIGNALING DESIGN AND CONFIGURATION

(71) Applicant: ZTE CORPORATION, Shenzhen (CN)

(72) Inventors: Shujuan ZHANG, Shenzhen (CN); Zhaohua LU, Shenzhen (CN); Bo GAO, Shenzhen (CN); Chuangxin JIANG, Shenzhen (CN); Hao WU, Shenzhen (CN)

(73) Assignee: ZTE CORPORATION, Shenzhen (CN)

(21) Appl. No.: 18/522,025

(22) Filed: Nov. 28, 2023

Related U.S. Application Data
(63) Continuation of application No. PCT/CN2021/109613, filed on Jul. 30, 2021.

(51) Int. Cl. H04W 74/0833; H04B 7/06; H04L 5/00; H04W 74/00

(52) U.S. Cl. CPC H04W 74/0833; H04B 7/0626; H04L 5/0051; H04W 74/006

(57) ABSTRACT

Embodiments of a system, device and method for configuring reference signaling are disclosed. In some embodiments, a method includes determining, by a wireless communication device, a reporting parameter, determining, by the wireless communication device, a second channel state information, and reporting, by the wireless communication device according to the reporting parameter, the second channel state information in a second message (msg) transmitted during a physical random access channel (PRACH) process.

### CROSS-REFERENCE TO RELATED APPLICATION

This application claims the benefit of priority under 35 U.S.C. § 120 as a continuation of PCT Patent Application No. PCT/CN2021/109613, filed on Jul. 30, 2021, the disclosure of which is incorporated herein by reference in its entirety.

### TECHNICAL FIELD

The disclosure relates generally to wireless communications and, more particularly, to systems and methods for designing and configuring reference signaling.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

Embodiments of a system, device and method for configuring reference signaling are disclosed. In some embodiments, a method includes determining, by a wireless communication device, a reporting parameter, determining, by the wireless communication device, a second channel state information, and reporting, by the wireless communication device according to the reporting parameter, the second channel state information in a second message (msg) transmitted during a physical random access channel (PRACH) process. In some embodiments, the reporting parameter includes at least one of: a channel measurement reference signal CMR parameter, information about reporting quantity, or a reporting resource. In some embodiments, the information about reporting quantity includes a type of information included in the second channel state information.

In some embodiments, a method includes receiving, by a wireless communication node from a wireless communication device, a second channel state information in a second message (msg) of a physical random access channel (PRACH) process. In some embodiments, the method includes transmitting, by the wireless communication node to the wireless communication device, a reporting parameter, via at least one of: system information or a msg of the PRACH process.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques and other aspects disclosed herein may be implemented, in accordance with an embodiment of the present disclosure.

FIG. 2 illustrates block diagrams of an example base station and a user equipment device, in accordance with some embodiments of the present disclosure.

FIG. 3 illustrates a method of reporting second channel state information in a second msg of a PRACH process according to a reporting parameter, in accordance with some embodiments.

FIG. 4 illustrates a method of receiving second channel state information in a second msg of a PRACH process, in accordance with some embodiments.

### DETAILED DESCRIPTION OF EXAMPLE EMBODIMENTS

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### A. Network Environment and Computing Environment

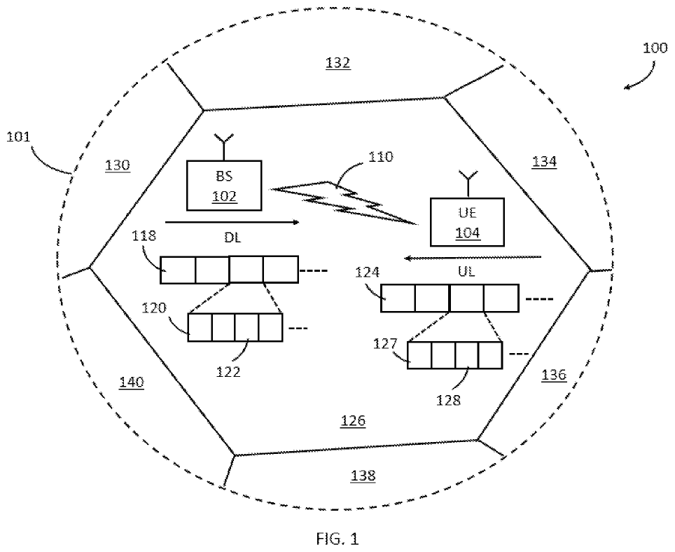

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IOT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

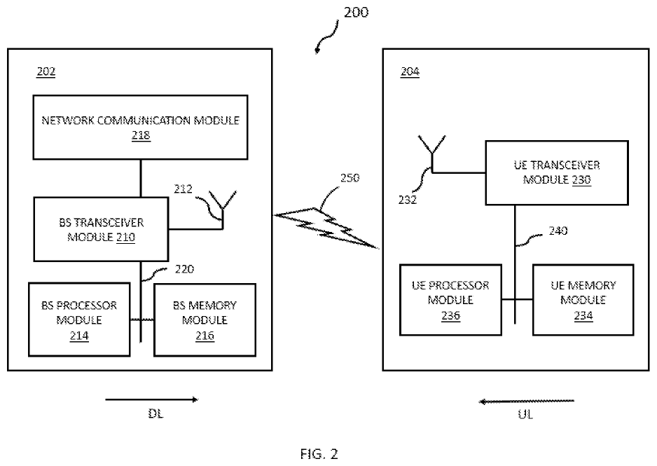

FIG. 2 illustrates a block diagram of an example wireless communication system 200 for transmitting and receiving wireless communication signals, e.g., OFDM/OFDMA signals, in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

### B. Reference Signaling Design And Configuration

Disclosed herein are embodiments of a system, apparatus, computer readable medium, and method for speeding up handover, improving a success rate of handover, reporting a layer 1 (L1, e.g., physical layer) measurement in message3 (msg3) and/or msgB, and/or configuring a higher priority in providing/sending a channel state information (CSI) reporting to neighboring cell.

In some embodiments, the UE reports CSI in msg3 or msgB during the PRACH process. In some embodiments, the msg3 or msgB includes certain information. In some embodiments, the UE resolves a slot structure configuration when the UE applies more than one set of parameters.

In some embodiments, the UE reports CSI (e.g., a second CSI) in a msg (e.g., a second msg) transmitted during PRACH process. In some embodiments, the CSI includes at least one of (1) one or more cell indexes, (2) a measurement result of each cell of the one or more cell indexes, (3) one or more reference signal resource indexes, (4) a number of the one or more cell indexes, (5) one or more reference signal resource indexes for each cell, (6) a measurement result of each of the one or more reference signal resource indexes, or (7) a number of the one or more reference signal resource indexes.

In some implementations, the cell index includes at least one of a PCI index, a serving cell index, or an index of parameter set. In some embodiments, one parameter set corresponds to one cell. In some implementations, the reference signal resource index includes at least one of an synchronization signal block (SSB) index, a CSI-RS resource index, an SSB resource indication SSB-RI. In some implementations, the measurement result includes at least one of an RSRP, an RSRQ, an SINR, or a channel quality indicator (CQI).

In some implementations, one cell corresponds to at least one of one PCI, a frequency resource configuration of a synchronization signal corresponding to the one PCI, a subcarrier space synchronization signal, or a serving cell. In some embodiments, when one cell corresponds to one PCI and the measurement includes PCI index and without frequency and sub-carrier spacing information, the frequency resource and the subcarrier space are same for the one or more PCIs reported in the channel state information.

In some implementations, the one or more reference signal resource indexes are for one of the one or more cell indexes. In some embodiments, the UE reports one or more reference signal indexes (e.g., indices) for each of the one or more cell indexes. In some implementations, the reported PCI or cell index is selected from N predefined cells. In some implementations, the msg including the channel state information CSI is at least one of a msg3 of a PRACH process or a msgA of a PRACH process.

In some implementations, the UE determines the reporting parameter for the CSI reporting included in the msg. In some embodiments, the reporting parameter includes at least one of channel measurement reference signal (CMR) parameter, information about reporting quantity, or a reporting resource. In some embodiments, the UE obtains reported CSI information based on the CMR and/or the information about reporting quantity. In some embodiments, the information about reporting quantity includes the information type included in the reported CSI information. In some embodiments, the information type included in the reported CSI information includes at least one of the type of measurement result for the reference signal resource index or the cell index, the number of the reported cell indexes, the number of the reported resource indexes, the number of the reported resource indexes per reported cell, the maximum number of the reported cell indexes, the maximum number of the reported resource indexes, or the maximum number of the reported resource indexes per reported cell. In some embodiments, the type of measurement result includes at least one of an RSRP, an RSRQ, an SINR, or a CQI. In some embodiments, the UE obtains the reporting parameter according at least one of a system information, a rule, or an indication from the msg2. For example, in some embodiments, the system information can indicate Z sets of reporting parameters, the msg2 indicates one of the Z sets of reporting parameters. In some embodiments, the reporting parameter is a fixed value. In some embodiments, the reporting resource includes a PUSCH resource index, and/or a PUCCH resource index. In some embodiments, the CMR channel measurement reference signal (CMR) parameter includes a set of cell index and/or a set of reference signal resource indexes. In some embodiments, the UE obtains the CSI information in the msg base on the set of cell index and/or a set of reference signal resource indexes. In some embodiments, the reference signal resource includes an SSB resource and/or a CSI-RS resource.

In some implementations, the CSI information is reported in msg3 (e.g., the second msg) and includes SSB resource index. In some embodiments, if the SSB index reported in the msg3 is different from the reported SSB index in msg1/msgA (e.g., the first msg), the UE determines which SSB index should be used to get the parameter of a channel or signal. Alternatively, the UE can determine which SSB index should be used to obtain the parameter of a channel or signal regardless the relationship between the SSB index reported in msg1/msgA and in msg3. In some embodiments, the SSB index is a quasi co-location reference signal (QCL-RS) of a downlink channel/signal and/or is used to determine the transmitting filter of an uplink channel/signal.

The UE can obtain/determine the QCL-RS and/or the transmitting filter according to at least one of following multiple methods. In some embodiments of a first method, the UE can still get/determine the QCL-RS and/or the transmitting filter according to the SSB index reported in the msg1/msgA after reporting the CSI in the msg3. In some embodiments, the UE still obtains a monitoring occasion of the CORESET 0 according to the SSB index reported in the msg1/msg A after reporting the CSI in the msg3. In some embodiments of a second method, the UE can obtain the QCL-RS and/or the transmitting filter according to both the SSB index reported in the msg1/msgA and the SSB index reported in the msg3. In some embodiments, one channel/signal corresponds to more than one SSB index including the SSB index reported in the msg1/msgA and the SSB index reported in the msg3. In some embodiments, the DMRS CORESET 0 is QCL-ed with the more than one SSB index. In some embodiments, the UE obtains a monitoring occasion of the CORESET 0 according to the more than one SSB index.

In some embodiments of a third method, the UE can update the QCL-RS and/or the transmitting filter from the SSB index reported in the msg1/msgA, to the SSB index reported in the msg3 after reporting the msg3. In some embodiments, the SSB index reported in the msg3 and the SSB index in the msg1/msgA is associated with one cell. In some embodiments, the UE determines a monitoring occasion of CORESET 0 after msg3 according to the SSB index reported in the msg3 after reporting the msg3. In some embodiments, the UE obtains the monitoring occasion of the CORESET 0 according to the more than one SSB index even if QCL-RS of other downlink channel/signal is obtained according to the SSB index in the msg3.

In some embodiments of a fourth method, the SSB reported in msg 1/msgA and msg3 are mapped to different TCI/SRI codepoints. In some embodiments, the DCI from gNB indicates one codepoint indication for the uplink channel/signal and/or downlink channel/signal. The UE can obtain the QCL-RS and/or the transmitting filter according to the codepoint indication. In some embodiments, one codepoint is mapped to a QCL-RS and/or the transmitting filter parameter. In some embodiments, the DCI 0_0 includes a sounding reference indication (SRI) field to indicate the one or more SSBs for the uplink channel/signal. The DCI 1_0 can include a TCI field to indicate the one or more SSBs for the downlink channel/signal.

In some embodiments, the UE determines which of the number of methods (e.g., the first method, the second method, the third method, and the fourth method) to adopt according to a signaling received from the base station or another UE. In some embodiments, the UE determines the QCL-RS and/or the transmitting filter according to at least one of the above multiple methods described, until the UE receives a dedicated configuration/RRC configuration for the QCL-RS/transmitting filter.

In some embodiments, the PCI reported in the msg1/msgA and the msg3 may be different. The UE can obtain the PCI for the channel/signal according to at least one of the above multiple methods. The PCI is used to generate a sequence for the signal or a scrambling sequence for the channel. In some embodiments, the UE determines whether to report the CSI in a msg of PRACH according to at least one of system information or information in msg2.

In the above description, the UE can report a first CSI information in msg 1 and reports a second CSI in msg A, and then the above process can also be applied.

In some embodiments, a priority of CSI reporting is determined according to a PCI associated with a CSI reporting. In some implementations, the priority of CSI reporting is determined according to whether the CSI reporting is associated with at least one PCI in a set of UE-Specific parameters or in a set of cell-specific parameters. For example, in some embodiments, the set of UE-specific parameters is configured in a UE-specific signaling. In some embodiments, the set of cell-specific parameters is configured in a UE-specific dedicated signaling or in a cell-specific common signaling. In some embodiments, even if the set of cell-specific parameters is configured in a UE-specific dedicated signaling, the set of cell-specific parameters is common for all UEs in the cell.

In some implementations, the priority of CSI reporting includes a first indication of whether a CSI reporting is associated with at least one PCI in a set of UE-Specific parameters. For example, in some embodiments, if a first CSI reporting is associated with at least one PCI in a set of UE-specific parameters, the first indicator is 0. In some embodiments, if a second CSI reporting is associated with no PCI in a set of UE-specific parameters, e.g., all PCIs associated with the CSI reporting are configured in cell-specific parameter set, the first indicator is 1. In some embodiments, the priority of CSI reporting is determined according to following parameters: (a) the first indicator p determined according to whether a CSI reporting is associated with at least one PCI in a set of UE-specific parameters, (b) a second indicator 1 determined according to a time domain behavior of the CSI reporting, (c) a third indicator m determined according to whether the CSI reporting includes an L1-RSRP reporting and/or an L1-SINR reporting, (d) a fourth indicator n determined according to a serving cell index associated with the CSI reporting, (e) a fifth indicator o determined according to index/indices of the CSI reporting among multiple CSI reportings associated with one serving cell and one same indicator of p, (f) a max number Rₚ of CSI reportings associated with one serving cell and one same indicator of p, and (g) a maximum number N_{cells} of the serving cells. For example, in some embodiments, the priority of the CSI reporting is obtained according to equation (1):

N_{priority,CSIreporting}=6*N_{cells}*Rₚ*p+2*N_{cells}*Rₚ*l+N_{cells}*Rₚ*m+Rₚ*n+o

In some embodiments, in equation (1), l=0 for aperiodic CSI reports to be carried on PUSCH, l=1 for semi-persistent CSI reports to be carried on PUSCH, l=2 for semi-persistent CSI reports to be carried on PUCCH, or 1=3 for periodic CSI reports to be carried on PUCCH. In some embodiments, m=0 for CSI reports carrying L1-RSRP or L1-SINR or m=1 for CSI reports not carrying L1-RSRP or L1-SINR. In some embodiments, n is the serving cell index.

In some embodiments, the priority of the CSI reporting is determined according to equation (2):

N_{priority CSIreporting}=2*N_{cell}*R*l+N_{cells}*R*m+R*n+o

In some embodiments, in equation (2), R is a max number of CSI reporting associated with one serving cell regardless of the value of p. In some embodiments, (a) m=0 for CSI reports carrying L1-RSRP or L1-SINR or the CSI reporting associated with at least one of PCIs configured in UE specific signaling or (b) m=1 for CSI reports not carrying L1-RSRP or L1-SINR and the CSI reporting associated with no PCI configured in UE specific signaling.

In some embodiments, priority of CSI reporting is determined/calculated according to whether the CSI reporting is associated with at least one neighboring PCI. The priority of the CSI reporting can be determined/calculated according to the method of determining a priority of CSI reporting according to a PCI associated with a CSI reporting except that PCI configured in UE-specific signaling is replaced with a neighboring (cell) PCI, and the PCI configured in cell-specific signaling is replaced with serve (or serving cell) PCI. In some implementations, if the CSI reporting is associated with at least one PCI in a set of UE-specific parameters, the CSI reporting may only be included in part 1 (e.g., a first part of the) reporting. In some implementations, if the CSI reporting is associated with at least one neighboring PCI, the CSI reporting only be included in part 1 reporting.

In some embodiments, the UE reports a channel state information in a UCI (uplink channel information) transmitted in PUCCH or PUSCH, or in a MAC-CE transmitted in PUSCH, or in a msg of PRACH process, wherein the channel state information includes at least one of the reference signal resource index and/or cell index. In some embodiments, the reference signal resource index includes SSB-RI and/or CRI. In some embodiments, the UE maps the reference signal resource index and/or cell index to a codepoint of a first DCI. In some embodiments, the the UE applies the mapping after receiving a second DCI from gNB (or another UE). Alternatively, in some embodiments, the UE determines a parameter of a channel/signal according to the reported channel state information after receiving the second DCI from gNB (or another UE).

The second DCI indicates a third information indicating that the mapping between content and a codepoint of a first DCI is updated according to the channel state information. In some embodiments, the content includes a reference signal resource index and/or cell index. Alternatively, in some embodiments, the second DCI indicates a fourth information indicating that the UE can determine the parameter of a channel/signal according to the reported channel state information. The second DCI and the first DCI can be a same DCI. The second DCI can indicate the third information and/or the fourth information by at least one of: a dedicate bit field for indicating above information, a predefined value of a codepoint of the second DCI, a dedicated radio network temporary identifier (RNTI), a predefined DCI format, or a predefined DCI in a predefined search space, wherein the codepoint of the second DCI and the codepoint of the first DCI can be a same DCI. In some embodiments, the codepoint of the first DCI or the second DCI includes an TCI codepoint, or an SRI codepoint. In some embodiments, the parameter of the channel/signal includes at least one of a quasi co-location reference signal (QCL-RS), a transmitting filter, a sequence of the signal, a scrambling sequence of the channel, or a monitoring occasion of control resource set 0 (CORESET0).

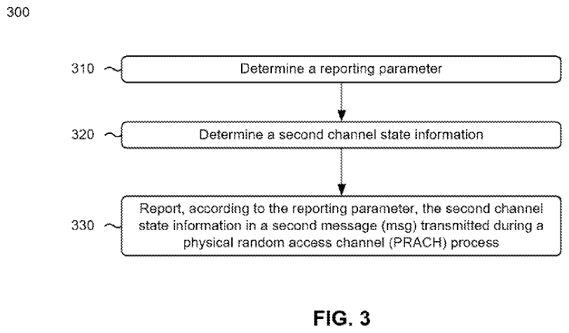

FIG. 3 illustrates a method 300 of reporting second channel state information in a second msg of a PRACH process according to a reporting parameter, in accordance with some embodiments. Referring to FIGS. 1-2, the method 300 can be performed by a wireless communication device (e.g., a UE) and/or a wireless communication node (e.g., base station, a gNB), in some embodiments. Additional, fewer, or different operations may be performed in the method 300 depending on the embodiment.

In brief overview, in some embodiments, a wireless communication device determines a reporting parameter (operation 310). In some embodiments, the wireless communication device determines a second channel state information (operation 320). In some embodiments, the wireless communication device reports, according to the reporting parameter, the second channel state information in a second message (msg) transmitted during a physical random access channel (PRACH) process (operation 330).

In more detail, at operation 310, in some embodiments, a wireless communication device determines a reporting parameter. In some embodiments, the wireless communication device is a UE. In some embodiments, the reporting parameter includes at least one of a channel measurement reference signal CMR parameter, information about reporting quantity or a reporting resource. In some embodiments, the information about reporting quantity includes a type of information included in the second channel state information.

At operation 320, in some embodiments, the wireless communication device determines a second channel state information. In some embodiments, the wireless communication device determines a parameter of a channel or signal according to the second channel state information. In some embodiments, the parameter of the channel or signal includes a quasi co-location reference signal (QCL-RS), a transmitting filter, a sequence of the signal, a scrambling sequence of the channel, or a monitoring occasion of control resource set 0 (CORESET0).

At operation 330, in some embodiments, the wireless communication device reports, according to the reporting parameter, the second channel state information in a second message (msg) transmitted during a physical random access channel (PRACH) process. In some embodiments, the wireless communication device determines the reporting parameter according to at least one of system information, a rule, an indication from a received msg of the PRACH process, or a fixed or predefined value.

In some embodiments, the wireless device at least one of (a) determines a parameter of a channel or signal only according to the first channel state information, (b) determines the parameter of the channel or signal according to both of the first channel state information and the second channel state information, (c) switches the parameter of the channel or signal associated with the first channel state information to the parameter of the channel or signal associated with the second channel state information, or (d) maps the first channel state information and the second channel state information to different codepoints of a downlink control information (DCI), after reporting the second msg.

In some embodiments, the wireless communication device transmits a first channel state information reported in a first msg of the PRACH process. In some embodiments, the wireless communication device determines a third channel state information based on at least one of the first channel state information or the second channel state information. In some embodiments, the wireless communication device determines a parameter of a channel or signal according to the third channel state information. In some embodiments, the third channel state includes one of the first channel state information, the second channel state information, or the first channel state information and the second channel state information.

In some embodiments, the first channel state information reported in the first msg of the PRACH process includes at least one of a resource index or a physical cell identifier (PCI) index reported in msg 1 or msg A. In some embodiments, the resource index includes at least one of a CSI reference signal (CSI-RS) resource indication (CRI), a synchronization signal block (SSB) resource indication (SSB-RI), or a SSB index. In some embodiments, the resource index in the msg1 is reported implicitly by transmitting a preamble in a PRACH occasion associated with the resource index. In some embodiments, (a) the parameter of the channel or signal is determined after reporting the second msg and/or (b) the first channel state information is different from the second channel state information.

In some embodiments, the wireless communication device determines at least one of (a) that downlink control information (DCI) 0_0 includes a sounding reference indication (SRI) field or (b) that DCI 1_0 includes a transmission configuration indicator (TCI) field. In some embodiments, the wireless communication device determines at least one (a) that downlink control information (DCI) 0_0 includes a sounding reference indication (SRI) field according to a first received information or (b) that DCI 1_0 includes a transmission configuration indicator (TCI) field according to a second received information. In some embodiments, at least one of the first received information or the second received information, include at least one of system information, or information on whether the wireless communication device will report the second channel state information in the second msg. In some embodiments if the wireless communication device is to report the second channel state information in the second msg, the wireless communication device determines at least one of (a) that the DCI 0_0 includes the SRI field or (b) that the DCI 1_0 includes the TCI field.

In some embodiments, the codepoints of the downlink control information includes one of a transmission configuration indicator (TCI) codepoint of downlink control information (DCI) 1_0, or a sounding reference indication (SRI) codepoint of DCI 0_0. In some embodiments, at least one of the second channel state information or the first channel state information, includesat least one of at least one cell index, a measurement result of each cell of the at least one cell index, at least one reference signal resource index, a number or count of the at least one cell index, at least one reference signal resource index for each cell of the at least one cell index, a number of the at least one reference signal resource index for each cell of the at least one cell index, a measurement result of each of the at least one reference signal resource index, or a number of the at least one reference signal resource index for each cell of the at least one cell index. In some embodiments, each of the at least one the reference signal resource index includes at least one of a CSI reference signal (CSI-RS) resource indication (CRI), a synchronization signal block (SSB) resource indication (SSB-RI), or a SSB index.

In some embodiments, the second msg includes: msg3 or msgA of the PRACH process. In some embodiments, the wireless communication node causes the wireless communication device to determines whether to report the second channel state information in the second msg according to at least one of system information, or information in msg2.

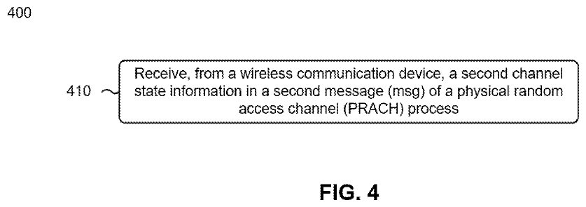

FIG. 4 illustrates a method 400 of receiving second channel state information in a second msg of a PRACH process, in accordance with some embodiments. Referring to FIGS. 1-2, the method 400 can be performed by a wireless communication device (e.g., a UE) and/or a wireless communication node (e.g., base station, a gNB), in some embodiments. Additional, fewer, or different operations may be performed in the method 400 depending on the embodiment.

At operation 410, a wireless communication node receives, from a wireless communication device, a second channel state information in a second message (msg) of a physical random access channel (PRACH) process. In some embodiments, the wireless communication device is a UE and the wireless communication node is either a gNB or another UE. In some embodiments, the wireless communication node transmits, to the wireless communication device, a reporting parameter, via at least one of system information or a msg of the PRACH process. In some embodiments, the reporting parameter includes at least one of a channel measurement reference signal CMR parameter, information about reporting quantity, or a reporting resource. In some embodiments, the information about reporting quantity includes a type of information included in the second channel state information. In some embodiments, the wireless communication device determines a parameter of a channel or signal according to the second channel state information.

In some embodiments, the wireless communication node receives, from the wireless communication device, a first channel state information in a first msg of the PRACH process. In some embodiments, the wireless communication node determines whether the first channel state information is different from the second channel state information. In some embodiments, the wireless communication node determines whether to use the first channel state information or the second information to determine a parameter of a channel or signal communicated with the wireless communication device.

In some embodiments, the wireless communication node receives, from the wireless communication device, a first channel state information in a first msg of the PRACH process. In some embodiments, the wireless communication node at least one of (a) determines a parameter of a channel or signal only according to the first channel state information, (b) determines the parameter of the channel or signal according to both of the first channel state information and the second channel state information, (c) switches from a parameter of the channel or signal associated with the first channel state information, to a parameter of the channel or signal associated with the second channel state information, or (d) maps the first channel state information and the second channel state information to different codepoints of a downlink control information (DCI), after reporting the second msg.

In some embodiments, the wireless communication node receives a first channel state information reported in a first msg of the PRACH process. In some embodiments, the wireless communication node determines a third channel state information using the first channel state information and the second channel state information. In some embodiments, the wireless communication node determines a parameter of a channel or signal according to the third channel state information. In some embodiments, the third channel state information includes one of the first channel state information, the second channel state information, or the first channel state information and the second channel state information.

In some embodiments, the first channel state information reported in the first msg of the PRACH process comprises at least one of a resource index or a physical cell identifier (PCI) index reported in msg 1 or msg A. In some embodiments, the resource index includes at least one of a CSI reference signal (CSI-RS) resource indication (CRI), a synchronization signal block (SSB) resource indication (SSB-RI), or a SSB index. In some embodiments, the resource index in the msg1 is reported implicitly by transmitting a preamble in a PRACH occasion associated with the resource index. In some embodiments, the parameter of the channel or signal includes: a quasi co-location reference signal (QCL-RS), a transmitting filter, a sequence of the signal, a scrambling sequence of the channel, or a monitoring occasion of control resource set 0 (CORESET0). In some embodiments, at least one of: the parameter of the channel or signal is determined after reporting the second msg, the channel or signal is sent by the wireless communication node to the wireless communication device, or the channel or signal is received by the wireless communication node from the wireless communication device, or the first channel state information is different from the second channel state information.

In some embodiments, the wireless communication node transmits, to the wireless communication device, at least one of (a) a downlink control information (DCI) 0_0 with a sounding reference indication (SRI) field or (b) a DCI 1_0 with a transmission configuration indicator (TCI) field. In some embodiments, the wireless communication node transmits, to the wireless communication device, at least one of (a) a first information which indicates whether a downlink control information (DCI) 0_0 includes a sounding reference indication (SRI) field according to a first received information or (b) a second information which indicates whether a DCI 1_0 includes a transmission configuration indicator (TCI) field according to a second received information.

In some embodiments, at least one of the first information or the second information, include at least one of system information, information on whether the wireless communication device will report the second channel state information in the second msg. In some embodiments, the wireless communication device is to report the second channel state information in the second msg. In some embodiments, the wireless communication node transmits, to the wireless communication device, at least one of (a) the DCI 0_0 with the SRI field or (b) the DCI 1_0 with the TCI field. In some embodiments, the codepoints of the downlink control information includes one of a transmission configuration indicator (TCI) codepoint of downlink control information (DCI) 1_0, or a sounding reference indication (SRI) codepoint of DCI 0_0.

In some embodiments, at least one of the second channel state information or the first channel state information, includes at least one of at least one cell index, a measurement result of each cell of the at least one cell index, at least one reference signal resource index, a number or count of the at least one cell index, at least one reference signal resource index for each cell of the at least one cell index, a number of the at least one reference signal resource index for each cell of the at least one cell index, a measurement result of each of the at least one reference signal resource index, or a number of the at least one reference signal resource index for each cell of the at least one cell index. In some embodiments, each of the at least one the reference signal resource index includes at least one of a CSI reference signal (CSI-RS) resource indication (CRI), a synchronization signal block (SSB) resource indication (SSB-RI), or a SSB index.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method comprising:
determining, by a wireless communication device, a reporting parameter;
determining, by the wireless communication device, a second channel state information; and
reporting, by the wireless communication device according to the reporting parameter, the second channel state information in a second message (msg) transmitted during a physical random access channel (PRACH) process.

2. The method of claim 1, wherein the reporting parameter includes at least one of: a channel measurement reference signal CMR parameter, information about reporting quantity, or a reporting resource,
wherein the information about reporting quantity includes a type of information included in the second channel state information.

3. The method of claim 1, further comprising:
determining, by the wireless communication device, the reporting parameter according to at least one of: system information, a rule, an indication from a received msg of the PRACH process, or a fixed or predefined value.

4. The method of claim 1, further comprising:
determining, by the wireless communication device, a parameter of a channel or signal according to the second channel state information.

5. The method of claim 1, further comprising:
transmitting, by the wireless communication device, a first channel state information in a first msg of the PRACH process;
the method further comprising at least one of:
determining, by the wireless communication device, a parameter of a channel or signal only according to the first channel state information;
determining, by the wireless communication device, the parameter of the channel or signal according to both of the first channel state information and the second channel state information;
switching, by the wireless communication device, the parameter of the channel or signal associated with the first channel state information to the parameter of the channel or signal associated with the second channel state information; or
mapping, by the wireless communication device, the first channel state information and the second channel state information to different codepoints of a downlink control information (DCI), after reporting the second msg.

6. The method of claim 1, further comprising:
transmitting, by the wireless communication device, a first channel state information reported in a first msg of the PRACH process;
determining, by the wireless communication device, a third channel state information based on at least one of the first channel state information or the second channel state information;
determining, by the wireless communication device, a parameter of a channel or signal according to the third channel state information.

7. The method of claim 5, wherein the first channel state information reported in the first msg of the PRACH process comprises at least one of:
a resource index or a physical cell identifier (PCI) index reported in msg 1 or msg A,
wherein the resource index includes at least one of: a CSI reference signal (CSI-RS) resource indication (CRI), a synchronization signal block (SSB) resource indication (SSB-RI), or a SSB index, and
wherein the resource index in the msg1 is reported implicitly by transmitting a preamble in a PRACH occasion associated with the resource index.

8. The method of claim 4, wherein:
the parameter of the channel or signal includes: a quasi co-location reference signal (QCL-RS), a transmitting filter, a sequence of the signal, a scrambling sequence of the channel, or a monitoring occasion of control resource set 0 (CORESET0).

9. The method of claim 4, wherein comprising at least one of:
the parameter of the channel or signal is determined after reporting the second msg;
the first channel state information is different from the second channel state information; or
the channel or signal is sent by the wireless communication device to a wireless communication node, or the channel or signal is received by the wireless communication device from the wireless communication node.

10. The method of claim 1, further comprising at least one of:
determining, by the wireless communication device, that downlink control information (DCI) 0_0 includes a sounding reference indication (SRI) field; or
determining, by the wireless communication device, that DCI 1_0 includes a transmission configuration indicator (TCI) field.

11. The method of claim 1, further comprising at least one of:
determining, by the wireless communication device, that downlink control information (DCI) 0_0 includes a sounding reference indication (SRI) field according to a first received information; or
determining, by the wireless communication device, that DCI 1_0 includes a transmission configuration indicator (TCI) field according to a second received information.

12. The method of claim 11, wherein at least one of: the first received information or the second received information, include at least one of: system information, or information on whether the wireless communication device will report the second channel state information in the second msg.

13. The method of claim 12, wherein if the wireless communication device is to report the second channel state information in the second msg, the method further comprises at least one of:
determining, by the wireless communication device, that the DCI 0_0 includes the SRI field; or
determining, by the wireless communication device, that the DCI 1_0 includes the TCI field.

14. The method of claim 5, wherein the codepoints of the downlink control information includes one of: a transmission configuration indicator (TCI) codepoint of downlink control information (DCI) 1_0, or a sounding reference indication (SRI) codepoint of DCI 0_0.

15. The method of claim 1, wherein at least one of: the second channel state information or the first channel state information, comprises at least one of: at least one cell index; a measurement result of each cell of the at least one cell index; at least one reference signal resource index; a number or count of the at least one cell index; at least one reference signal resource index for each cell of the at least one cell index; a number of the at least one reference signal resource index for each cell of the at least one cell index; a measurement result of each of the at least one reference signal resource index; or a number of the at least one reference signal resource index for each cell of the at least one cell index,
wherein each of the at least one the reference signal resource index includes at least one of: a CSI reference signal (CSI-RS) resource indication (CRI), a synchronization signal block (SSB) resource indication (SSB-RI), or a SSB index.

16. The method of claim 1, wherein the second msg includes: msg3 or msgA of the PRACH process.

17. The method of claim 1, further comprising:
causing the wireless communication device to determine whether to report the second channel state information in the second msg according to at least one of: system information, or information in msg2.

18. A method comprising:
receiving, by a wireless communication node from a wireless communication device, a second channel state information in a second message (msg) of a physical random access channel (PRACH) process.

19. A wireless communication device, comprising:
at least one processor configured to:
determine a reporting parameter;
determine a second channel state information; and
report, via a transmitter according to the reporting parameter, the second channel state information in a second message (msg) transmitted during a physical random access channel (PRACH) process.

20. A wireless communication node, comprising:
at least one processor configured to:
receive, via a receiver from a wireless communication device, a second channel state information in a second message (msg) of a physical random access channel (PRACH) process.
